(19) United States
(12) Patent Application Publication
(10) Pub. No.: US 2024/0303974 A1
(43) Pub. Date: Sep. 12, 2024

(54) LEARNING DATA GENERATION APPARATUS AND METHOD, AND LEARNING MODEL GENERATION APPARATUS AND METHOD

(71) Applicant: FUJIFILM Corporation, Tokyo (JP)

(72) Inventor: Masaaki OOSAKE, Kanagawa (JP)

(73) Assignee: FUJIFILM Corporation, Tokyo (JP)

(21) Appl. No.: 18/665,605

(22) Filed: May 16, 2024

Related U.S. Application Data
(63) Continuation of application No. PCT/JP2022/039844, filed on Oct. 26, 2022.

(30) Foreign Application Priority Data
Nov. 22, 2021 (JP) 2021-189296

(51) Int. Cl. G06V 10/774; G06V 10/10; G06V 10/44; G06V 10/82

(52) U.S. Cl. CPC G06V 10/774; G06V 10/16; G06V 10/44; G06V 10/82; G06V 2201/031

(57) ABSTRACT

There are provided a learning data generation apparatus and method and a learning model generation apparatus and method that can attain efficient learning. The learning data generation apparatus acquires first image data and second image data each having a region of interest, and when a positional relationship between the region of interest of the first image data and the region of interest of the second image data satisfies a predetermined condition, combines an image of a region, of the first image data, that includes the region of interest and an image of a region, of the second image data, that includes the region of interest to generate third image data. The learning model generation apparatus acquires the third image data generated by the learning data generation apparatus and trains a learning model by using the third image data to generate the learning model.

### CROSS-REFERENCE TO RELATED APPLICATIONS

The present application is a Continuation of PCT International Application No. PCT/JP2022/039844 filed on Oct. 26, 2022 claiming priority under 35 U.S.C § 119(a) to Japanese Patent Application No. 2021-189296 filed on Nov. 22, 2021. Each of the above applications is hereby expressly incorporated by reference, in its entirety, into the present application.

### BACKGROUND OF THE INVENTION

### 1. Field of the Invention

The present invention relates to a learning data generation apparatus and method and a learning model generation apparatus and method and specifically relates to a learning data generation apparatus and method for a learning model for performing image recognition and a learning model generation apparatus and method.

### 2. Description of the Related Art

Recently, generation of a learning model having high recognition accuracy for performing image recognition has become possible with deep learning (see, for example, A. Krizhevsky, I. Sutskever, and G. Hinton, ImageNet Classification with Deep Convolutional Neural Networks, In NIPS, 2012) as long as a large amount of learning data is available.

JP2021-157404A describes a technique in which a recognition target image is combined with an image to be used as an input image upon learning to thereby increase the amount of learning data.

JP2020-60883A describes a technique in which an image of a specific area is extracted from a recognition target image and the image of the extracted area is subjected to an image conversion process and combined with the recognition target image to thereby increase the variations of learning data.

### SUMMARY OF THE INVENTION

However, it is pointed out that learning using a large amount of learning data takes a lot of time.

One embodiment of the technique of the present disclosure provides a learning data generation apparatus and method and a learning model generation apparatus and method that can attain efficient learning.

(1) A learning data generation apparatus that generates learning data, including: a processor, the processor being configured to: acquire first image data and second image data each having a region of interest; and when a positional relationship between the region of interest of the first image data and the region of interest of the second image data satisfies a predetermined condition, combine an image of a region, of the first image data, that includes the region of interest and an image of a region, of the second image data, that includes the region of interest to generate third image data.

(2) The learning data generation apparatus according to (1), in which the predetermined condition includes a condition that the region of interest of the first image data is located in a first region in an image and that the region of interest of the second image data is located in a second region different from the first region in the image.

(3) The learning data generation apparatus according to (2), in which the predetermined condition includes a condition that the region of interest of the first image data is located in the first region so as to be spaced apart from a boundary line that separates the first region and the second region by a threshold value or more and that the region of interest of the second image data is located in the second region so as to be spaced apart from the boundary line by the threshold value or more.

(4) The learning data generation apparatus according to (2) or (3), in which the predetermined condition includes a condition that a plurality of regions of interest of the first image data are located in the first region so as to be spaced apart from a boundary line that separates the first region and the second region by a threshold value or more and that a plurality of regions of interest of the second image data are located in the second region so as to be spaced apart from the boundary line by the threshold value or more.

(5) The learning data generation apparatus according to (3) or (4), in which when the learning data is used in training of a neural network using a convolution process, the threshold value is set on the basis of a size of a receptive field of a convolution layer in a first layer.

(6) The learning data generation apparatus according to any one of (2) to (5), in which the processor is configured to combine an image of the first region of the first image data and an image of a region, of the second image data, other than the first region to generate the third image data.

(7) The learning data generation apparatus according to (6), in which the processor is configured to overwrite an image of a region, of the first image data, other than the first region with the image of the region, of the second image data, other than the first region to generate the third image data.

(8) The learning data generation apparatus according to any one of (1) to (7), in which the predetermined condition includes a condition that the region of interest of the first image data and the region of interest of the second image data are spaced apart from each other by a threshold value or more.

(9) The learning data generation apparatus according to (8), in which the processor is configured to: set a boundary line that separates a plurality of regions of an image, between the region of interest of the first image data and the region of interest of the second image data; and combine an image of a region, of the first image data, that includes the region of interest among a plurality of regions, of the first image data, separated by the boundary line and an image of a region, of the second image data, that includes the region of interest among a plurality of regions, of the second image data, separated by the boundary line to generate the third image data.

(10) The learning data generation apparatus according to (9), in which the processor is configured to overwrite an image of other than the region, of the first image data, that includes the region of interest with the image of the region, of the second image data, that includes the region of interest to generate the third image data.

(11) The learning data generation apparatus according to any one of (8) to (10), in which when the learning data is used in training of a neural network using a convolution process, the threshold value is set on the basis of a size of a receptive field of a convolution layer in a first layer.

(12) The learning data generation apparatus according to any one of (1) to (11), in which the processor is configured to: acquire first ground truth data that indicates a ground truth of the first image data and second ground truth data that indicates a ground truth of the second image data; and generate third ground truth data that indicates a ground truth of the third image data from the first ground truth data and the second ground truth data.

(13) The learning data generation apparatus according to (12), in which the processor is configured to generate third ground truth data that indicates a ground truth of the third image data from the first ground truth data and the second ground truth data in accordance with a condition for generating the third image data from the first image data and the second image data.

(14) The learning data generation apparatus according to (12) or (13), in which each of the first ground truth data and the second ground truth data is mask data for the region of interest.

(15) A learning model generation apparatus that generates a learning model, including: a processor, the processor being configured to: acquire third image data generated by the learning data generation apparatus according to any one of (1) to (14); and train the learning model by using the third image data.

(16) The learning model generation apparatus according to (15), in which the processor is configured to train the learning model by further using at least one image data among first image data and second image data used in generation of the third image data.

(17) The learning model generation apparatus according to (16), in which the processor is configured to perform training using the third image data and training using at least one of the first image data or the second image data.

(18) The learning model generation apparatus according to any one of (15) to (17), in which the processor is configured to train the learning model while excluding a boundary region, of the third image data, in image combination.

(19) A learning data generation method for generating learning data, including: a step of acquiring first image data and second image data each having a region of interest; a step of determining whether the region of interest of the first image data and the region of interest of the second image data have a specific positional relationship; and a step of, when a positional relationship between the region of interest of the first image data and the region of interest of the second image data satisfies a predetermined condition, combining an image of a region, of the first image data, that includes the region of interest and an image of a region, of the second image data, that includes the region of interest to generate third image data.

(20) A learning model generation method for generating a learning model, including: a step of acquiring first image data and second image data each having a region of interest; a step of, when a positional relationship between the region of interest of the first image data and the region of interest of the second image data satisfies a predetermined condition, combining an image of a region, of the first image data, that includes the region of interest and an image of a region, of the second image data, that includes the region of interest to generate third image data; and a step of training the learning model by using the third image data.

According to the present invention, efficient learning can be attained.

### BRIEF DESCRIPTION OF THE DRAWINGS

FIG. 1 is a diagram illustrating example learning data;

FIG. 2 is a conceptual diagram of generation of learning data;

FIG. 3 is a diagram illustrating example image division;

FIG. 4 is a diagram illustrating an example case where the position of a lesion part is not successfully identified;

FIG. 5 is a diagram illustrating example new image data;

FIG. 6 is a diagram illustrating example new ground truth data;

FIG. 7 is a block diagram illustrating an example hardware configuration of a learning data generation apparatus;

FIG. 8 is a block diagram of main functions of the learning data generation apparatus;

FIG. 9 is a flowchart illustrating an example procedure of a new learning data generation process;

FIG. 10 is a diagram illustrating an example case of combining four pieces of image data;

FIG. 11 is a diagram illustrating an example case of dynamically changing and setting a boundary line;

FIG. 12 is a diagram illustrating example new image data that is generated;

FIG. 13 is a conceptual diagram of a determination as to whether to allow combination;

FIG. 14 is a block diagram of main functions of the learning data generation apparatus;

FIG. 15 is a flowchart illustrating an example procedure of the new learning data generation process;

FIG. 16 is a diagram illustrating another example of setting a boundary line;

FIG. 17 is a diagram illustrating an example case of dynamically changing and setting a boundary line in accordance with learning data to be combined;

FIG. 18 is a diagram illustrating an example of setting a boundary line when learning data has a plurality of regions of interest; and

FIG. 19 is a block diagram of main functions of a learning model generation apparatus.

### DESCRIPTION OF THE PREFERRED EMBODIMENTS

Hereinafter, preferred embodiments of the present invention will be described with reference to the attached drawings.

### Learning Data Generation Apparatus (Learning Data Generation Method)

### First Embodiment

An example case of generating a learning model for recognizing a lesion part from an image (endoscopic image) of a luminal organ, such as the stomach or the large intestine, captured with an endoscope will be described here. Specifically, an example case of generating a learning model for recognizing a region occupied by a lesion part in an image, that is, a learning model for performing image segmentation (specifically, semantic segmentation), will be described. In this case, as the learning model, for example, U-net, FCN (Fully Convolutional Network), SegNet, PSPNet (Pyramid Scene Parsing Network), or Deeplabv3+ can be used. These are a type of neural network that uses a convolution process, that is, convolutional neural network (CNN or ConvNet).

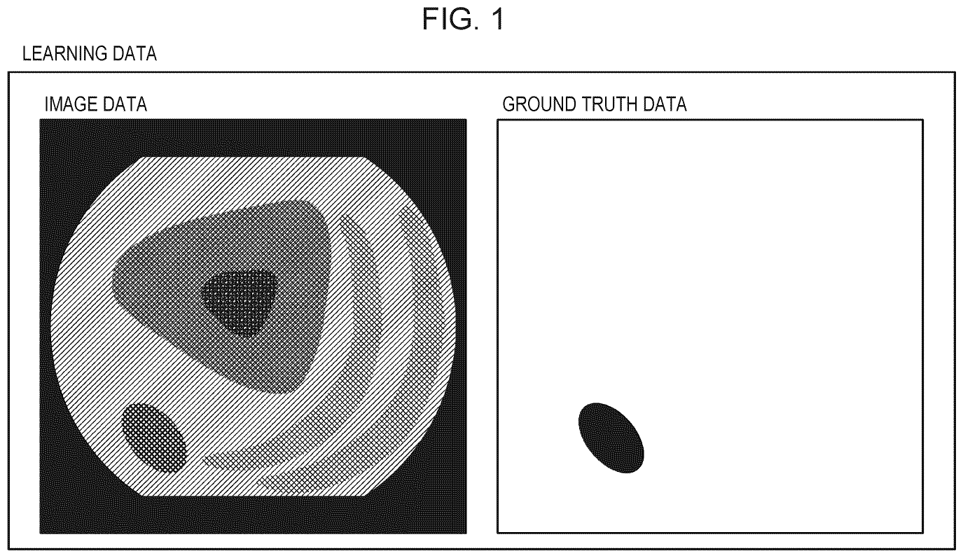

FIG. 1 is a diagram illustrating example learning data.

As illustrated in FIG. 1, the learning data is formed of a pair of image data and ground truth data.

The image data is image data for learning. The image data for learning is formed of image data that includes a recognition target. As described above, in this embodiment, a learning model for recognizing a lesion part from an image captured with an endoscope is generated. Therefore, the image data for learning is formed of image data acquired by image capturing with an endoscope and is formed of image data including a lesion part. Specifically, the image data for learning is formed of image data of an image of an organ that is an image recognition target, the image being captured with an endoscope. For example, in a case of recognizing a lesion part of the stomach, the image data for learning is formed of image data acquired by image capturing of the stomach with an endoscope.

The ground truth data is data that indicates a ground truth of the image data for learning. In this embodiment, the ground truth data is formed of image data of an image that the image data for learning represents and in which a lesion part is distinguished from the other part. FIG. 1 illustrates an example case where the ground truth data is formed of a mask image. In this case, the ground truth data is formed of image data of an image in which the lesion part is masked (an image in which the lesion part is filled). The image data of the image in which the lesion part is masked is an example of mask data.

As described above, learning data is formed of a pair of image data and ground truth data (image pair). A large number of pieces of learning data each formed of this image pair are made ready to build a dataset, and the built dataset is used to train a learning model.

### Overview of Learning Data Generation

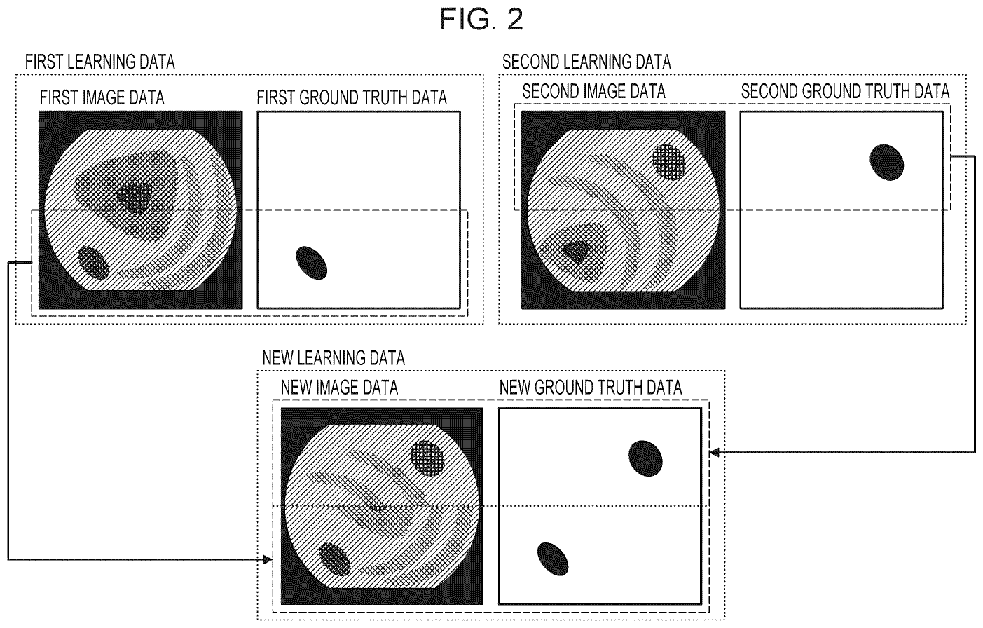

FIG. 2 is a conceptual diagram of generation of learning data.

As illustrated in FIG. 2, in this embodiment, two pieces of learning data are combined to newly generate learning data.

The newly generated learning data is referred to as “new learning data”. Image data and ground truth data that form the new learning data are referred to as “new image data” and “new ground truth data”, respectively.

The two pieces of learning data for generating the new learning data are referred to as “first learning data” and “second learning data”, respectively. Image data and ground truth data that form the first learning data are referred to as “first image data” and “first ground truth data”, respectively. Image data and ground truth data that form the second learning data are referred to as “second image data” and “second ground truth data”, respectively.

New learning data is generated as follows.

First, learning data in which a recognition target is included in the image data is acquired. The acquired learning data is assumed to be first learning data. In this embodiment, the image data is image data acquired by image capturing with an endoscope, and the recognition target is a lesion part. The lesion part is an example of a region of interest.

Next, for the image data (first image data) that forms the first learning data, a region, in the image, in which the lesion part is located is identified. In this embodiment, the image that the image data represents is divided into two regions, and it is determined in which of the regions the lesion part is located.

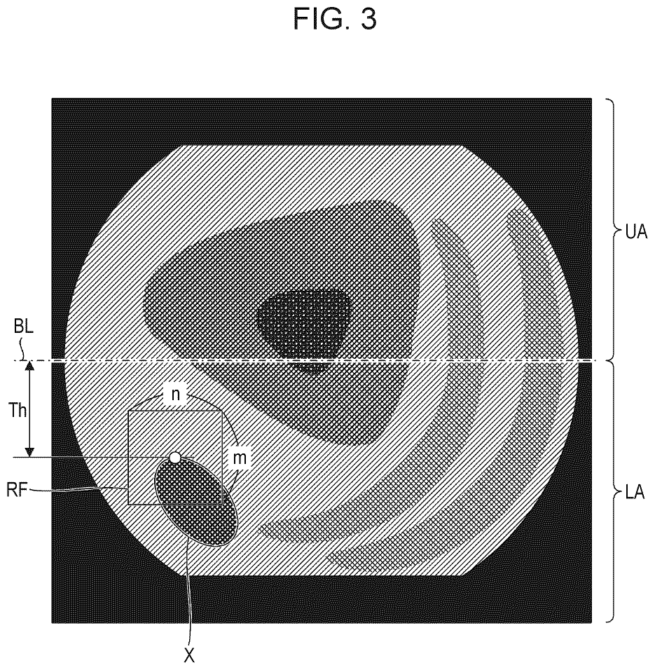

FIG. 3 is a diagram illustrating example image division.

As illustrated in FIG. 3, in this embodiment, the image is equally divided into upper and lower regions. The straight line that separates the regions is assumed to be a boundary line BL. The region on the upper side of the boundary line BL is referred to as an upper-side region UA, and the region on the lower side thereof is referred to as a lower-side region LA. FIG. 3 illustrates an example case where a lesion part X is present in the lower-side region LA. Therefore, in the example illustrated in FIG. 3, it is determined that the lesion part X is located in the lower-side region LA.

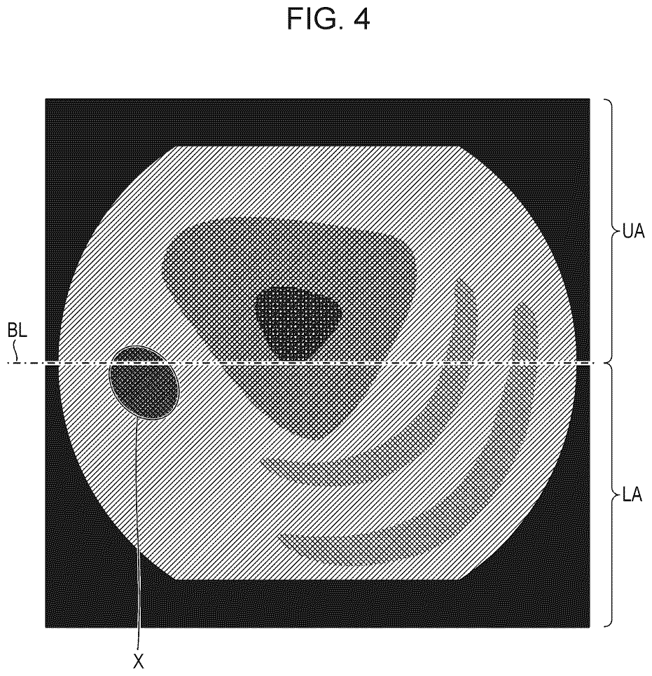

FIG. 4 is a diagram illustrating an example case where the position of a lesion part is not successfully identified.

As illustrated in FIG. 4, in a case where the lesion part X is present so as to extend across the two regions, it is not possible to determine in which of the regions the lesion part is located. Therefore, in this case, it is determined that the position of the lesion part is not successfully identified.

The case where the lesion part X is present so as to extend across the two regions is a case where the lesion part X is present on the boundary line BL. Therefore, a condition for identifying the position of the lesion part X is that the lesion part X is not present on the boundary line BL.

Furthermore, in this embodiment, in order to determine that the lesion part X is located in the upper-side region UA or the lower-side region LA, the following matter is assumed to be a requirement. That is, the state in which the lesion part X is spaced apart from the boundary line BL by a threshold value Th or more is assumed to be a requirement.

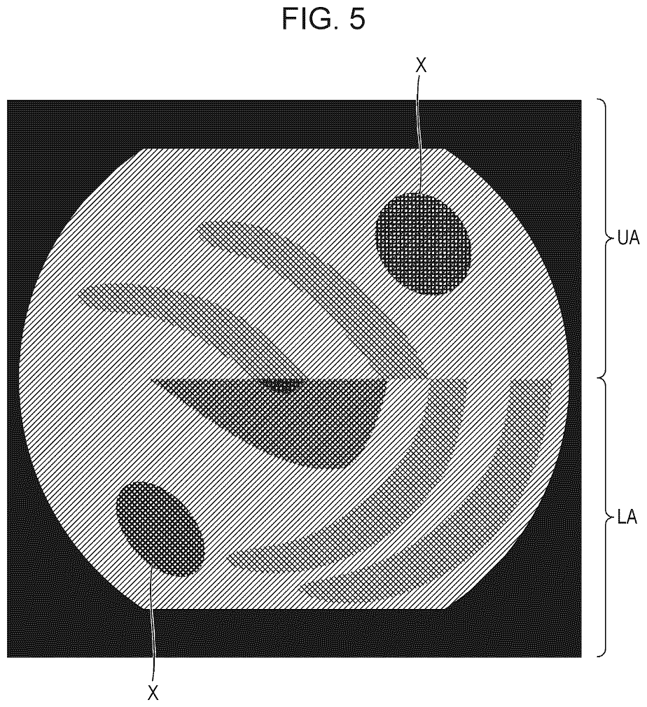

As described above, in this embodiment, two pieces of image data (first image data and second image data) are combined to generate new image data. As described below, new image data is generated by combining the upper-side region of the first image data and the lower-side region of the second image data. Alternatively, new image data is generated by combining the lower-side region of the first image data and the upper-side region of the second image data. That is, the image of the region on one side of the first image data and the image of the region on the opposite side of the second image data are joined together along the boundary line BL to generate new image data. In the new image data thus generated, the image changes on the joint line (see FIG. 5). Therefore, when a lesion part is present in the vicinity of the joint line, a part in which the image changes may be reflected in learning. That is, an image that is not present in reality may be reflected in learning.

Accordingly, in this embodiment, the state in which the lesion part X is not present in the vicinity of the boundary line BL, that is, the lesion part X is spaced apart from the boundary line BL by the threshold value Th or more, is assumed to be a requirement. This requirement is set from the viewpoint of influence on learning. Therefore, the threshold value Th is set from the viewpoint of influence on learning. Accordingly, in a case of using generated learning data in training of a neural network using a convolution process, it is preferable to set the threshold value Th on the basis of the size of a receptive field. Specifically, it is preferable to set the threshold value Th on the basis of the size of the receptive field of a convolution layer in the first layer. For example, as illustrated in FIG. 3, it is assumed that the size (length×width) of a receptive field RF of a convolution layer in the first layer is m×n. In this embodiment, the boundary line BL is horizontally set, and therefore, the threshold value Th is set to a value that is at least greater than m/2. Accordingly, in at least the convolution layer in the first layer, it is possible to prevent the region of a lesion part, including a region in which the image changes, from being convoluted, and to suppress reflection of the part, in which the image changes, in learning.

The state in which the lesion part X is spaced apart from the boundary line BL by the threshold value Th or more means that the distance between a pixel, among the pixels that form the lesion part X, located at a position closest to the boundary line BL and the boundary line BL is greater than or equal to the threshold value Th.

When the position of the lesion part is not successfully identified from the image data in the learning data acquired as first learning data, the next learning data is acquired. That is, the above-described process is repeated until learning data in which the position of the lesion part is successfully identified is acquired.

After the position of the lesion part X is identified in the first image data, learning data to be used in combination is acquired. Learning data that is acquired is learning data in which a recognition target is included in the image data as in the first learning data. The image data is image data acquired by image capturing with an endoscope. The acquired learning data is assumed to be second learning data.

Next, for the image data (second image data) that forms the second learning data, it is determined whether the lesion part is located in a specific region in the image. Here, the specific region is a region in which the lesion part is not located in the first image data that is a combination target. Therefore, the specific region changes depending on the region in which the lesion part is located in the first image data that is a combination target. When the lesion part is located in the upper-side region UA in the first image data that is a combination target, the lower-side region LA is the specific region. In this case, the upper-side region UA is an example of a first region, and the lower-side region LA is an example of a second region. On the other hand, when the lesion part is located in the lower-side region LA in the first image data that is a combination target, the upper-side region UA is the specific region. In this case, the lower-side region LA is an example of the first region, and the upper-side region UA is an example of the second region.

In order to determine that the lesion part is located in the specific region in the second image data, the state in which the lesion part is located in the specific region so as to be spaced apart from the boundary line BL by the threshold value Th or more is assumed to be a requirement.

When the lesion part is located in the specific region in the second image data, it is assumed that the positional relationship between the lesion part of the first image data and the lesion part of the second image data satisfies a predetermined condition, and combination is performed to generate new image data. Combination is performed as follows. The image of the region that includes the lesion part of the first image data and the image of the region that includes the lesion part of the second image data are combined to generate new image data. Therefore, for example, when the lesion part is located in the upper-side region of the first image data, the image of the upper-side region of the first image data and the image of the lower-side region of the second image data are combined to generate new image data. On the other hand, when the lesion part is located in the lower-side region of the first image data, the image of the lower-side region of the first image data and the image of the upper-side region of the second image data are combined to generate new image data.

FIG. 5 is a diagram illustrating example new image data.

As illustrated in FIG. 5, image data in which the lesion part X is included in each of the upper-side region UA and the lower-side region LA of the image is generated as new image data. In this embodiment, new image data is an example of third image data.

Note that the technique for combination is not specifically limited. For example, a technique for combination by overwriting can be employed. That is, a technique for combination can be employed in which the image of a partial region (a region other than a region that includes a region of interest) of one of the pieces of image data is overwritten with the image of an applicable region (a region that includes a region of interest) of the other piece of image data. For example, when a region of interest is located in the upper-side region of first image data, the image of the lower-side region (a region that includes a region of interest) is cut from second image data, and the image of the lower-side region (a region other than the region that includes the region of interest) of the first image data is overwritten with the cut image. Alternatively, the image of the upper-side region (the region that includes the region of interest) is cut from the first image data, and the image of the upper-side region (a region other than the region that includes the region of interest) of the second image data is overwritten with the cut image. In addition, a technique can be employed in which the images of regions to be combined are cut from respective pieces of image data and combined. For example, when a region of interest is located in the upper-side region of first image data, the image of the upper-side region is cut from the first image data, and the image of the lower-side region is cut from second image data. The images cut from the respective pieces of image data are joined together to generate new image data.

For ground truth data, combination is similarly performed to generate new ground truth data. That is, first ground truth data and second ground truth data are combined on a condition the same as that for new image data to generate new ground truth data. For example, when the image of the upper-side region of first image data and the image of the lower-side region of second image data are combined to generate new image data, the image of the upper-side region of first ground truth data and the image of the lower-side region of second ground truth data are combined to generate new ground truth data. On the other hand, when the image of the lower-side region of first image data and the image of the upper-side region of second image data are combined to generate new image data, the image of the lower-side region of first ground truth data and the image of the upper-side region of second ground truth data are combined to generate new ground truth data. In this embodiment, new ground truth data is an example of third ground truth data.

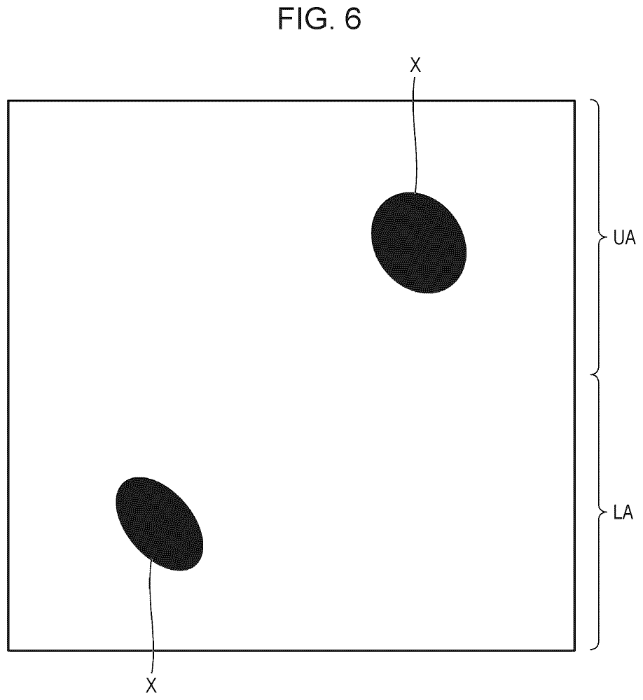

FIG. 6 is a diagram illustrating example new ground truth data. FIG. 6 illustrates data that indicates a ground truth of the new image data illustrated in FIG. 5.

As illustrated in FIG. 6, an image (mask image) that includes the lesion part X in each of the upper-side region UA and the lower-side region LA of the image so as to correspond to the new image data (see FIG. 5) is generated as new ground truth data.

When the lesion part is not located in the specific region of image data in the learning data acquired as second learning data, the next learning data is acquired. That is, the above-described process is repeated until learning data in which the lesion part is located in the specific region is acquired.

As described above, in this embodiment, new image data is generated by combining image data in which the lesion part (region of interest) is included in one (first region) of the regions acquired by equally dividing the image into upper and lower regions and image data in which the lesion part (region of interest) is included in the other region (second region). Images are combined on a condition the same as that for the new image data to generate new ground truth data. Accordingly, learning data, that is, one piece of learning data that includes two lesion parts (regions of interest), can be generated. Furthermore, the amount of learning data can be reduced as well.

### Hardware Configuration

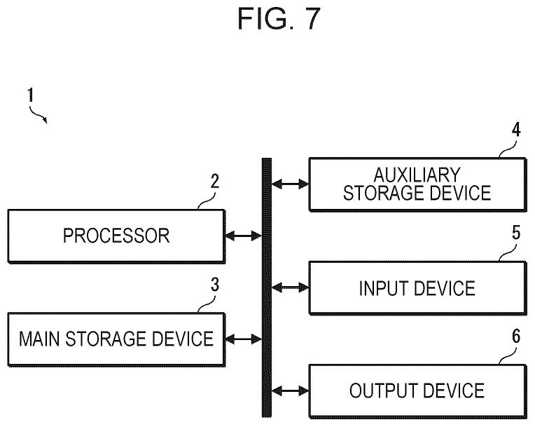

FIG. 7 is a block diagram illustrating an example hardware configuration of a learning data generation apparatus.

A learning data generation apparatus 1 is formed of, for example, a computer and includes a processor 2, a main storage device (main memory) 3, an auxiliary storage device (storage) 4, an input device 5, and an output device 6. That is, the learning data generation apparatus 1 of this embodiment functions as a learning data generation apparatus by the processor 2 executing a predetermined program (learning data generation program). In the auxiliary storage device 4, a program to be executed by the processor 2 and various types of data necessary for, for example, processing are stored. Learning data necessary for generating new learning data and generated new learning data are stored in the auxiliary storage device 4 as well. The input device 5 includes a keyboard and a mouse as operation units and an input interface for taking in learning data necessary for generating new learning data. The output device 6 includes a display and an output interface for outputting, for example, generated new learning data.

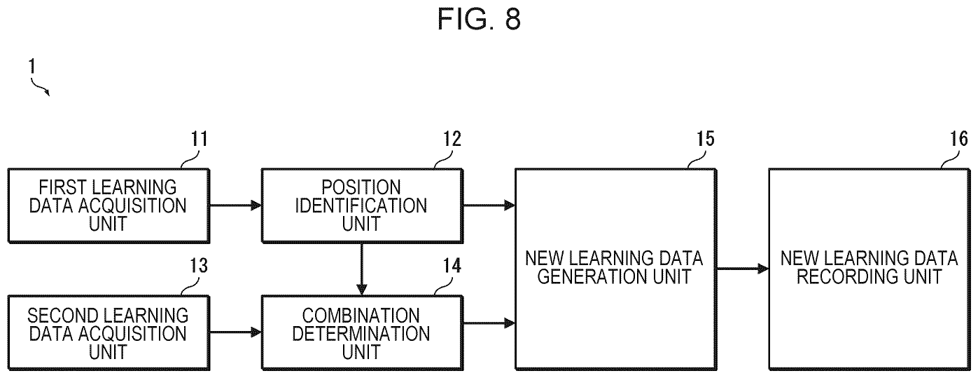

FIG. 8 is a block diagram of main functions of the learning data generation apparatus.

As illustrated in FIG. 8, the learning data generation apparatus 1 mainly has functions of, for example, a first learning data acquisition unit 11, a position identification unit 12, a second learning data acquisition unit 13, a combination determination unit 14, a new learning data generation unit 15, and a new learning data recording unit 16. The function of each unit is implemented by the processor 2 executing a predetermined program.

The first learning data acquisition unit 11 acquires learning data to be used as first learning data. In this embodiment, the first learning data acquisition unit 11 acquires learning data to be used as first learning data from the auxiliary storage device 4. Therefore, it is assumed that learning data is stored in advance in the auxiliary storage device 4. This learning data is learning data to be used in generation of new learning data. Therefore, the learning data is learning data that includes a region of interest in the image. The learning data is also used as second learning data.

The position identification unit 12 performs a process for identifying the position of a lesion part that is the region of interest in image data (first image data) that forms the first learning data. In this embodiment, the position identification unit 12 performs a process for determining in which of the upper-side region UA and the lower-side region LA the lesion part is located. As described above, in order to determine that the lesion part is located in the upper-side region UA or the lower-side region LA, the state in which the lesion part is located in the upper-side region UA or the lower-side region LA so as to be spaced apart from the boundary line BL by the threshold value Th or more is a requirement.

The second learning data acquisition unit 13 acquires learning data to be used as second learning data. As described above, the second learning data acquisition unit 13 acquires learning data to be used as second learning data from the auxiliary storage device 4.

The combination determination unit 14 performs a process for determining whether combination of the acquired second learning data is allowed. Specifically, the combination determination unit 14 determines whether the lesion part is located in the specific region in image data (second image data) that forms the second learning data. As described above, the specific region is a region in which the lesion part is not located in the first image data that is a combination target. When the lesion part is located in the upper-side region UA in the first image data that is a combination target, the lower-side region LA is the specific region. On the other hand, when the lesion part is located in the lower-side region LA in the first image data that is a combination target, the upper-side region UA is the specific region. When determining that the lesion part is located in the specific region in the acquired second learning data, the combination determination unit 14 determines that combination is allowed. In order to determine that the lesion part is located in the specific region, the state in which the lesion part is located in the specific region so as to be spaced apart from the boundary line BL by the threshold value Th or more is a requirement.

The new learning data generation unit 15 performs a process for generating new learning data. Specifically, the new learning data generation unit 15 combines the first learning data and the second learning data for which it is determined that combination with the first learning data is allowed, to generate new learning data. At this time, when the lesion part is located in the upper-side region UA of the first image data, the image of the upper-side region UA of the first image data and the image of the lower-side region LA of the second image data are combined to generate new image data. On the other hand, when the lesion part is located in the lower-side region LA of the first image data, the image of the lower-side region LA of the first image data and the image of the upper-side region UA of the second image data are combined to generate new image data. Similarly to generation of the new image data, new ground truth data is generated. That is, new ground truth data is generated on a condition the same as the condition for generating the new image data. Therefore, for example, when the lesion part is located in the upper-side region UA of the first image data, the image of the upper-side region UA of the first ground truth data and the image of the lower-side region LA of the second ground truth data are combined to generate new ground truth data. On the other hand, when the lesion part is located in the lower-side region LA of the first image data, the image of the lower-side region LA of the first ground truth data and the image of the upper-side region UA of the second ground truth data are combined to generate new ground truth data.

The new learning data recording unit 16 performs a process for recording the new learning data generated by the new learning data generation unit 15. For example, in this embodiment, the new learning data recording unit 16 records the generated new learning data in the auxiliary storage device 4.

### New Learning Data Generation Process

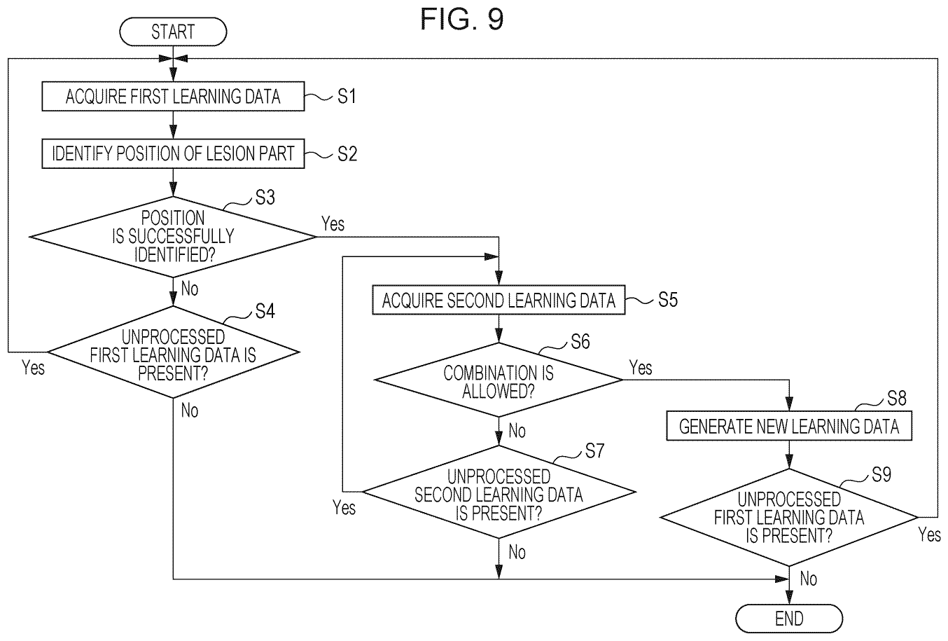

FIG. 9 is a flowchart illustrating an example procedure of a new learning data generation process.

First, the processor 2 acquires first learning data (step S1). Specifically, the processor 2 reads one of the plurality of pieces of learning data stored in the auxiliary storage device 4 to acquire first learning data.

Next, the processor 2 identifies the position of the lesion part in the acquired first learning data (step S2). Specifically, the processor 2 determines in which of the upper-side region and the lower-side region the lesion part is located in image data (first image data) that forms the first learning data. On the basis of the result of the determination process, the processor 2 determines whether the position of the lesion part is successfully identified (step S3).

If the position of the lesion part is not successfully identified in step S2 (in a case of No in step S3), the processor 2 determines whether unprocessed first learning data is present (step S4). That is, the processor 2 determines whether a piece of learning data that is not yet used as first learning data is present. If unprocessed first learning data is not present, the process ends. On the other hand, if unprocessed first learning data is present, the flow returns to step S1, and the processor 2 acquires the unprocessed first learning data and performs the processes in step S2 and the subsequent steps. That is, the processor 2 changes the first learning data that is a processing target.

If the position of the lesion part is successfully identified in step S2 (in a case of Yes in step S3), next, the processor 2 acquires second learning data (step S5). Similarly to the first learning data, the processor 2 reads one of the plurality of pieces of learning data stored in the auxiliary storage device 4 to acquire second learning data.

Next, the processor 2 determines whether combination of the acquired second learning data is allowed (step S6). Specifically, the processor 2 determines whether the lesion part is located in the specific region in image data (second image data) that forms the second learning data. As described above, the specific region is determined on the basis of the first learning data that is a combination target. When the lesion part is located in the upper-side region of the first image data in the first learning data that is a combination target, the lower-side region is set as the specific region. On the other hand, when the lesion part is located in the lower-side region of the first image data in the first learning data that is a combination target, the upper-side region is set as the specific region.

If it is determined that combination is not to allowed, the processor 2 determines whether unprocessed second learning data is present (step S7). That is, the processor 2 determines whether a piece of learning data that is not yet used as second learning data is present. If unprocessed second learning data is not present, the process ends. On the other hand, if unprocessed second learning data is present, the flow returns to step S5, and the processor 2 acquires the unprocessed second learning data and determines whether combination is allowed (step S6). That is, the processor 2 changes the second learning data that is a processing target.

On the other hand, if it is determined that combination is allowed, the processor 2 performs a process for generating new learning data (step S8). That is, the processor 2 combines the first image data of the first learning data and the second image data of the second learning data to generate new image data of new learning data. The processor 2 combines first ground truth data of the first learning data and second ground truth data of the second learning data to generate new ground truth data of the new learning data.

Here, new image data is generated by combining the image of a region that includes the lesion part of the first image data and the image of a region that includes the lesion part of the second image data. Therefore, for example, when the lesion part is included in the upper-side region of the first image data, the image of the upper-side region of the first image data and the image of the lower-side region of the second image data are combined to generate new image data. For example, when the lesion part is included in the lower-side region of the first image data, the image of the lower-side region of the first image data and the image of the upper-side region of the second image data are combined to generate new image data. Similarly, the first ground truth data and the second ground truth data are combined to generate new ground truth data. The generated new learning data is stored in the auxiliary storage device 4.

After generating the new learning data, the processor 2 determines whether unprocessed first learning data is present (step S9). That is, the processor 2 determines whether a piece of learning data that is not yet used as first learning data is present. If unprocessed first learning data is not present, the process ends. On the other hand, if unprocessed first learning data is present, the flow returns to step S1, and the processor 2 uses an unprocessed piece of learning data as a target to start generation of new learning data.

Note that a piece of learning data that has been used in generation of new learning data is regarded as a piece of processed learning data and is not used in generation of new learning data thereafter. Similarly, a piece of learning data that has been acquired as first learning data and for which the position of the lesion part has not been successfully identified is regarded as a piece of processed learning data as well. Therefore, the piece of learning data that has been acquired as first learning data and for which the position of the lesion part has not been successfully identified is not used in generation of new learning data thereafter. On the other hand, a piece of learning data that has been acquired as second learning data and for which it has been determined that combination is not allowed is not regarded as a piece of processed learning data. This is because there is a possibility that this piece of learning data can be used as first learning data and can be combined with another piece of learning data.

As described above, with the learning data generation apparatus 1 of this embodiment, new learning data can be generated by extracting only a region that includes the lesion part from each of the two pieces of learning data. Accordingly, the amount of learning data can be reduced, and the time taken for learning can be reduced. That is, efficient learning can be attained.

### Modifications

Case where Learning Data to be Combined has Plurality of Regions of Interest

Although a case where the number of regions of interest (lesion parts) included in each of first learning data and second learning data is one has been described in the above-described embodiment, the present invention is applicable not only to this case. The present invention is similarly applicable to a case where learning data to be used as a combination target has a plurality of regions of interest. In this case, it is preferable that all of the regions of interest satisfy a condition for combination (predetermined condition). For example, in a case where an image is equally divided into two regions, namely, the upper and lower regions, and combined as in the above-described embodiment, for first learning data, it is preferable to assume the state in which all regions of interest included in the image data (first image data) are located in the upper-side region or the lower-side region to be a condition. Similarly, for second learning data, it is preferable to assume the state in which all regions of interest included in the image data (second image data) are located in the specific region to be a condition. Accordingly, new image data acquired by using information about all regions of interest included in the learning data can be generated.

In order to determine that all regions of interest included in first image data are located in the upper-side region or the lower-side region, it is preferable to further assume the following matter to be a requirement. It is more preferable to assume the state in which all regions of interest included in first image data are located in the upper-side region or the lower-side region so as to be spaced apart from the boundary line by a threshold value or more to be a requirement. Similarly, in order to determine that all regions of interest included in second image data are located in the specific region, it is preferable to assume the state in which all regions of interest included in the second image data are located in the specific region so as to be spaced apart from the boundary line by the threshold value or more to be a requirement. Accordingly, reflection of a part of the joint line of the image in learning can be suppressed.

### Division of Region

Although an example case where an image is divided into two regions, namely, the upper and lower regions, and combined has been described in the above-described embodiment, the form of division is not limited to this. In addition, for example, a technique in which an image is equally divided into two regions in the lateral direction and combined can be employed. Alternatively, a technique in which an image is equally divided into two regions diagonally and combined can be employed.

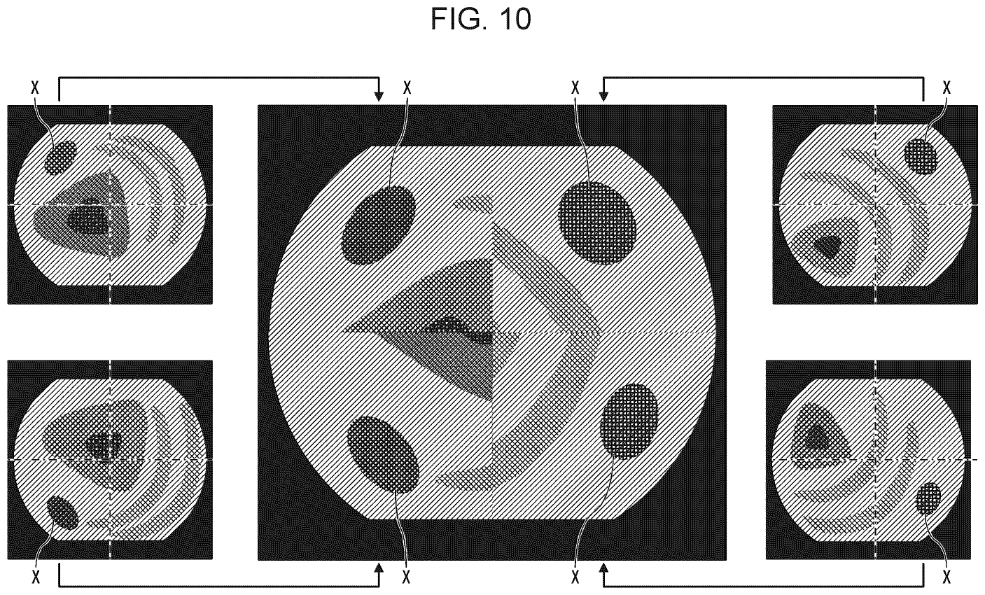

Although a case of combining two pieces of learning data has been described in the above-described embodiment, the number of pieces of learning data to be combined is not limited to two. Three or more pieces of learning data can be combined to generate new learning data. In this case, the image is divided in accordance with the number of pieces of learning data to be combined. For example, in a case of combining three pieces of learning data to generate new learning data, the image is divided into three regions. Similarly, in a case of combining four pieces of learning data to generate new learning data, the image is divided into four regions. The form of division is not specifically limited. For example, in the case of combining three pieces of learning data, the image is divided into three regions in the longitudinal direction or the lateral direction. Alternatively, the image is divided into three regions in the circumferential direction. For example, in the case of combining four pieces of learning data, the image is divided into four regions in the longitudinal direction or the lateral direction. Alternatively, the image is divided into four regions in the circumferential direction. The images of corresponding regions of the respective pieces of learning data are combined on a divided-region-by-divided-region basis to generate new learning data. FIG. 10 is a diagram illustrating an example case of combining four pieces of image data. FIG. 10 illustrates an example case of equally dividing each image into four regions in the circumferential direction and combining four pieces of image data. In a first region (upper left region) of the new image data, the image of the first region of first image data is disposed. In a second region (upper right region), the image of the second region of second image data is disposed. In a third region (lower left region), the image of the third region of third image data is disposed. In a fourth region (lower right region), the image of the fourth region of fourth image data is disposed. Here, image data selected as the first image data is image data having the lesion part (region of interest) X in the first region (upper left region). Image data selected as the first image data is image data having the lesion part X in the second region (upper right region). Image data selected as the third image data is image data having the lesion part X in the third region (lower left region). Image data selected as the fourth image data is image data having the lesion part X in the fourth region (lower right region).

### Setting of Boundary Line

Although the above-described embodiment employs a configuration in which the boundary line is fixed and the images of the predetermined regions are combined, a configuration may be employed in which the position of the boundary line is dynamically changed in accordance with the position of the region of interest included in image data (first image data) of first learning data. In this case, a region whose image is combined changes in accordance with the position of the region of interest included in the first image data.

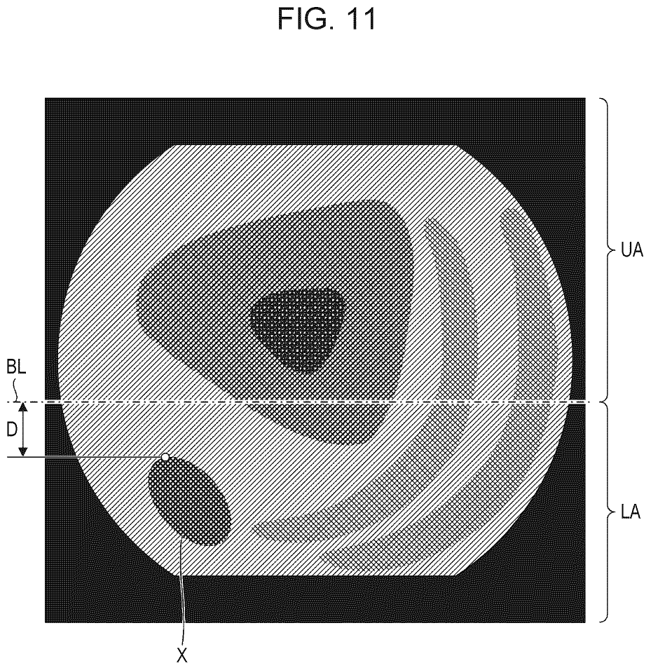

FIG. 11 is a diagram illustrating an example case of dynamically changing and setting a boundary line. FIG. 11 illustrates an example case of dynamically changing and setting the boundary line BL that separates two regions, namely, the upper and lower regions, of the image.

First, the position of the lesion part (region of interest) X is identified in the image of first image data. Next, the distance from the upper end of the lesion part X to the upper side of the image is calculated. The upper end of the lesion part X is synonymous with the uppermost pixel among the pixels that form the lesion part X. Similarly, the distance from the lower end of the lesion part X to the lower side of the image is calculated. The lower end of the lesion part X is synonymous with the lowermost pixel among the pixels that form the lesion part X. The calculated distances are compared with each other, and a region corresponding to a longer distance is selected as a set region in which the boundary line BL is set. FIG. 11 illustrates an example case where a region on the upper side of the lesion part X is selected as the set region in which the boundary line BL is set. The boundary line BL is set in the selected set region. At this time, the boundary line BL is set at a distance D from the upper end of the lesion part X.

Here, the distance D is set from the viewpoint of influence on learning as in the case of the threshold value Th in the above-described embodiment. Therefore, in a case of using generated learning data in training of a neural network using a convolution process, the distance D is set on the basis of the size of a receptive field, specifically, the size of the receptive field of a convolution layer in the first layer.

As described above, the boundary line can be set on a per learning-data basis in accordance with the position of the region of interest included in image data of first learning data.

In the example illustrated in FIG. 11, as second image data that is a combination target, image data in which the lesion part is included in a region on the upper side of the boundary line BL is selected.

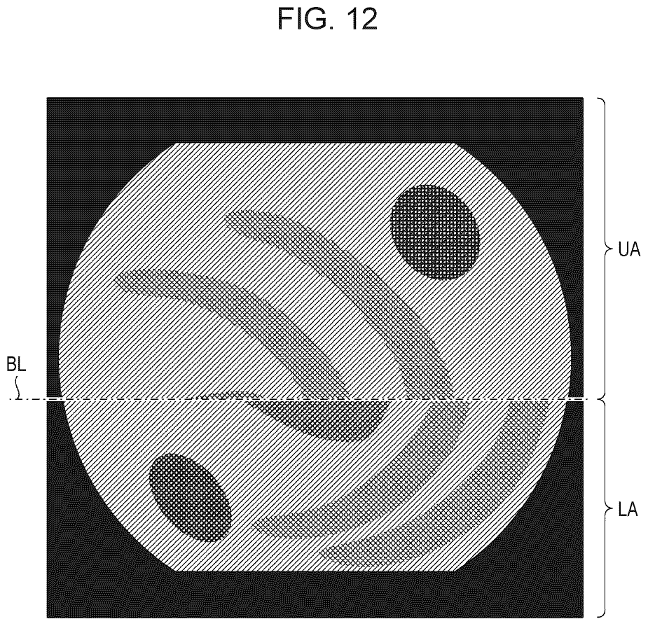

FIG. 12 is a diagram illustrating example new image data.

As illustrated in FIG. 12, image data in which the image of the first image data is disposed on the lower side of the set boundary line BL and the image of the second image data is disposed on the upper side thereof is generated as new image data.

### Form of Boundary Line

Although the boundary line is formed of a horizontal straight line in the above-described embodiment, the boundary line can be formed of an oblique straight line. The boundary line can be formed of a curved line instead of a straight line. Further, the boundary line can be formed of a straight line that is bent in part (that is, a broken line).

### Second Embodiment

### Overview

In this embodiment, in a case of combining two pieces of learning data to generate new learning data, whether combination of the two pieces of learning data is allowed is determined on the basis of the distance between the regions of interest included in the respective piece of learning data.

A learning data generation method according to this embodiment will be briefly described below. An example case where an image is divided into two regions, namely, the upper and lower regions, and combined will be described here. As in the first embodiment described above, an example case of generating a learning model for recognizing a lesion part (region of interest) from an endoscopic image will be described.

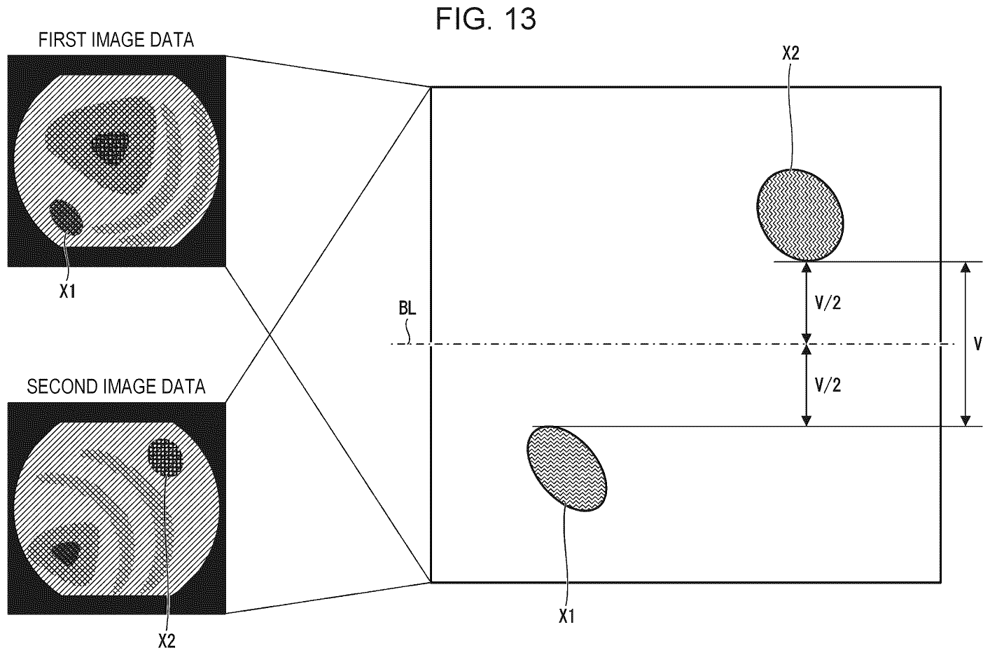

FIG. 13 is a conceptual diagram of a determination as to whether to allow combination.

The lesion part included in first image data is referred to as a first lesion part X1, and the lesion part included in second image data is referred to as a second lesion part X2.

The distance between the first lesion part X1 and the second lesion part X2 is calculated, and it is determined, on the basis of the calculated distance, whether combination is allowed.

Here, the distance between the first lesion part X1 and the second lesion part X2 is the distance between the lesion parts in image data on which the first image data and the second image data are superimposed. That is, the distance between the first lesion part X1 and the second lesion part X2 is the distance between the lesion parts when the first image data and the second image data are superimposed. In this embodiment, an image is divided in the up-down direction and combined, and therefore, the distance V in the up-down direction (longitudinal direction) of the image is calculated.

When the calculated distance V is greater than or equal to a threshold value ThV, it is determined that combination is allowed. That is, when the first lesion part X1 and the second lesion part X2 are spaced apart from each other by the threshold value ThV or more, it is determined that combination is allowed. Here, the threshold value Th V is set from the viewpoint of influence on learning as in the case of the threshold value Th in the first embodiment described above. Therefore, in a case of using generated learning data in training of a neural network using a convolution process, the threshold value Th Vis set on the basis of the size of a receptive field, specifically, the size of the receptive field of a convolution layer in the first layer. For example, when the size (length×width) of the receptive field of the convolution layer in the first layer is m×n, the threshold value ThV is set to a value that is at least greater than m.

When combination of the two pieces of image data is allowed, the boundary line BL is set between the two lesion parts X1 and X2. In this embodiment, an image is divided into two regions, namely, the upper and lower regions, and combined, and therefore, the boundary line BL that is a horizontal line is set. The boundary line BL is set so as to be located midway between the two lesion parts X1 and X2.

After the boundary line BL is set, each image is divided along the set boundary line BL, and the images of regions each including the lesion part are combined to generate new image data. In the example illustrated in FIG. 13, the image of the lower-side region of the first image data and the image of the upper-side region of the second image data are combined to generate new image data.

In this embodiment, the distance V between the first lesion part X1 and the second lesion part X2 is an example of a positional relationship. The condition for determining that combination is allowed, that is, the condition that the distance V is greater than or equal to the threshold value ThV, is an example of a predetermined condition.

### Hardware Configuration

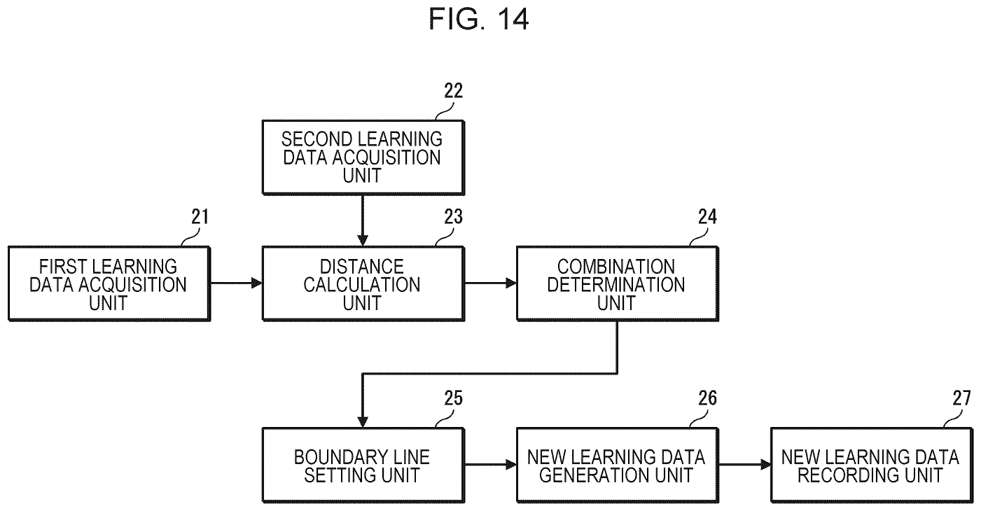

FIG. 14 is a block diagram of main functions of the learning data generation apparatus.

As illustrated in FIG. 14, the learning data generation apparatus mainly has functions of, for example, a first learning data acquisition unit 21, a second learning data acquisition unit 22, a distance calculation unit 23, a combination determination unit 24, a boundary line setting unit 25, a new learning data generation unit 26, and a new learning data recording unit 27. The function of each unit is implemented by the processor 2 executing a predetermined program.

The first learning data acquisition unit 21 performs a process for acquiring learning data to be used as first learning data. In this embodiment, the first learning data acquisition unit 21 acquires learning data to be used as first learning data from the auxiliary storage device 4.

The second learning data acquisition unit 22 performs a process for acquiring learning data to be used as second learning data. Similarly to the first learning data, the second learning data acquisition unit 22 acquires learning data to be used as second learning data from the auxiliary storage device 4.

The distance calculation unit 23 performs a process for calculating the distance between the lesion part included in the first learning data and the lesion part included in the second learning data. That is, the distance calculation unit 23 calculates the distance between the lesion part (first lesion part) included in image data (first image data) of the first learning data and the lesion part (second lesion part) included in image data (second image data) of the second learning data. In this embodiment, the distance V in the up-down direction of the image is calculated.

The combination determination unit 24 performs a process for determining whether combination of the two pieces of learning data is allowed, on the basis of the distance calculated by the distance calculation unit 23. Specifically, the combination determination unit 24 determines whether combination is allowed, on the basis of whether the distance V calculated by the distance calculation unit 23 is greater than or equal to the threshold value ThV. When the distance V is greater than or equal to the threshold value ThV, the combination determination unit 24 determines that combination is allowed.

The boundary line setting unit 25 performs a process for setting a boundary line when combination of the two pieces of learning data is allowed. In this embodiment, the boundary line setting unit 25 sets a horizontal boundary line that is located midway between the two lesion parts (the middle position in the up-down direction) (see FIG. 13).

The new learning data generation unit 26 performs a process for combining the first learning data and the second learning data to generate new learning data. Specifically, the new learning data generation unit 26 divides each image on the basis of the set boundary line and combines the images of regions that include the respective lesion parts to generate new learning data. For example, when the lesion part is located in the region on the lower side of the set boundary line in the first learning data, the new learning data generation unit 26 combines the image of the region of the first image data on the lower side of the boundary line and the image of the region of the second image data on the upper side of the boundary line to generate new image data. For ground truth data, the new learning data generation unit 26 similarly combines the image of the region of the first ground truth data on the lower side of the boundary line and the image of the region of the second ground truth data on the upper side of the boundary line to generate new ground truth data. For example, when the lesion part is located in the region on the upper side of the set boundary line in the first learning data, the new learning data generation unit 26 combines the image of the region of the first image data on the upper side of the boundary line and the image of the region of the second image data on the lower side of the boundary line to generate new image data. For ground truth data, the new learning data generation unit 26 similarly combines the image of the region of the first ground truth data on the upper side of the boundary line and the image of the region of the second ground truth data on the lower side of the boundary line to generate new ground truth data. As in the first embodiment described above, the technique for combination is not specifically limited. For example, a technique for combination by overwriting or a technique in which the images of regions to be combined are cut from respective pieces of image data and combined can be employed.

### New Learning Data Generation Process

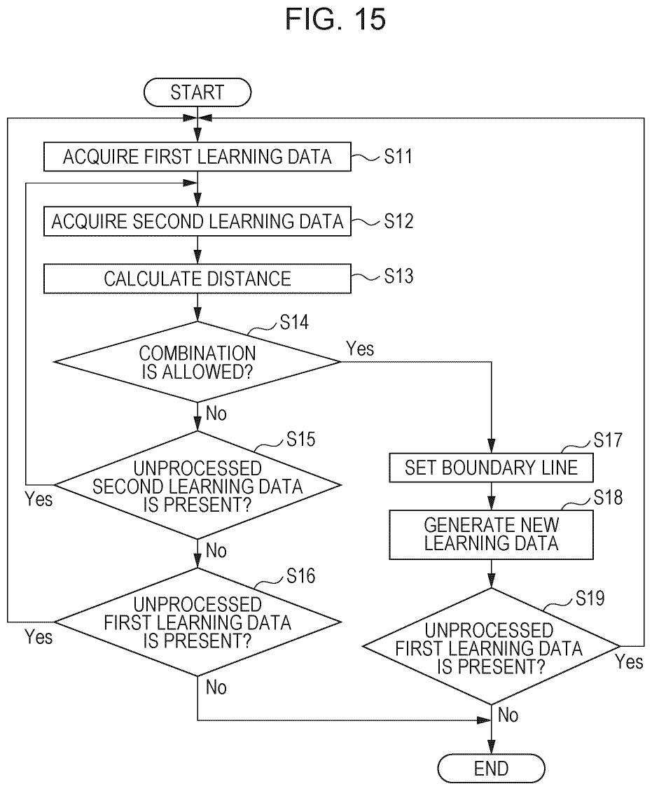

FIG. 15 is a flowchart illustrating an example procedure of the new learning data generation process.

First, the processor 2 acquires first learning data (step S11). Specifically, the processor 2 reads one of the plurality of pieces of learning data stored in the auxiliary storage device 4 to acquire first learning data.

Next, the processor 2 acquires second learning data (step S12). Similarly to the first learning data, the processor 2 reads one of the plurality of pieces of learning data stored in the auxiliary storage device 4 to acquire second learning data.

Next, the processor 2 calculates the distance between the lesion parts (between regions of interest) respectively included in the acquired first learning data and second learning data (step S13). That is, the processor 2 calculates the distance V (the distance in the up-down direction of the image) between the lesion part (first lesion part) included in image data (first image data) of the first learning data and the lesion part (second lesion part) included in image data (second image data) of the second learning data. The distance described here is the distance between the lesion parts when the images of the respective pieces of image data are superimposed (see FIG. 13).

Next, the processor 2 determines, on the basis of the calculated distance, whether combination of the two pieces of learning data is allowed (step S14). Here, the processor 2 determines whether the calculated distance V is greater than or equal to the threshold value ThV to thereby determine whether combination is allowed. When the calculated distance Vis greater than or equal to the threshold value Th V, the processor 2 determines that combination is allowed. On the other hand, when the calculated distance V is less than the threshold value ThV, the processor 2 determines that combination is not allowed.

If it is determined that combination is not allowed, the processor 2 determines whether unprocessed second learning data is present (step S15). That is, the processor 2 determines whether a piece of learning data that is not yet used as second learning data is present.

If pieces of unprocessed second learning data are present, the flow returns to step S12, and the processor 2 acquires one of the pieces of unprocessed second learning data and calculates the distance between the lesion parts respectively included in the newly acquired second learning data and the first learning data (step S13). That is, the processor 2 changes the second learning data and determines again whether combination is allowed.

On the other hand, if unprocessed second learning data is not present, the processor 2 determines whether unprocessed first learning data is present (step S16). That is, the processor 2 determines whether a piece of learning data that is not yet used as first learning data is present. If unprocessed first learning data is not present, the process ends. On the other hand, if pieces of unprocessed first learning data are present, the flow returns to step S11, and the processor 2 acquires one of the pieces of unprocessed first learning data and newly starts the process. That is, the processor 2 changes the first learning data and starts the new learning data generation process.

If it is determined in step S14 that combination is allowed, the processor 2 sets a boundary line (step S17). In this embodiment, the processor 2 sets the boundary line BL that separates two regions, namely, the upper and lower regions, of the image (see FIG. 13). The boundary line BL is set so as to be located midway between the first lesion part X1 and the second lesion part X2 (the middle position of the image in the up-down direction).

After setting the boundary line BL, the processor 2 generates new learning data (step S18). That is, the processor 2 generates new image data and new ground truth data.

New image data is generated by combining the image of a region, of the first image data, that includes the lesion part and the image of a region, of the second image data, that includes the lesion part. Therefore, for example, when the lesion part is included in the region on the upper side of the boundary line BL in the first image data, the image of the region of the first image data on the upper side of the boundary line BL and the image of the region of the second image data on the lower side of the boundary line BL are combined to generate new image data. For example, when the lesion part is included in the region on the lower side of the boundary line BL in the first image data, the image of the region of the first image data on the lower side of the boundary line BL and the image of the region of the second image data on the upper side of the boundary line are combined to generate new image data. Similarly, the first ground truth data and the second ground truth data are combined to generate new ground truth data. The generated new learning data is stored in the auxiliary storage device 4.

After generating the new learning data, the processor 2 determines whether unprocessed first learning data is present (step S19). If unprocessed first learning data is not present, the process ends. On the other hand, if pieces of unprocessed first learning data are present, the flow returns to step S11, and the processor 2 acquires one of the pieces of unprocessed first learning data and newly starts the new learning data generation process.

Note that a piece of learning data that has been used in generation of new learning data is regarded as a piece of processed learning data and is not used in generation of new learning data thereafter. Similarly, first learning data for which it is determined that combination is not allowed (first learning data for which second learning data that is allowed to be combined is not present) is regarded as a piece of processed learning data as well. Second learning data for which it is determined that combination is not allowed is not regarded as a piece of processed learning data when the first learning data is changed. This is because there is a possibility that the second learning data can be combined with other first learning data.

As described above, according to this embodiment, new learning data can be generated by extracting only a region that includes the lesion part from each of the two pieces of learning data as in the first embodiment. Accordingly, the amount of learning data can be reduced, and the time taken for learning can be reduced. That is, efficient learning can be attained.

### Modifications

### Form of Image Division

Although an example case where an image is divided into two regions, namely, the upper and lower regions, and combined has been described in the above-described embodiment, the form of image division is not limited to this. The boundary line is set in accordance with the form of image division.

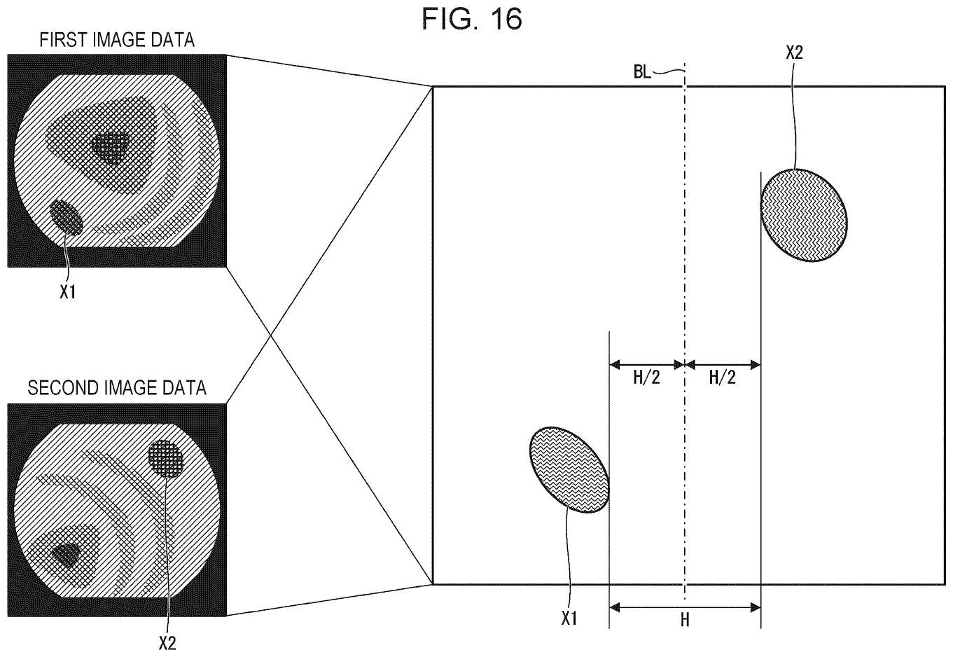

FIG. 16 is a diagram illustrating another example of setting a boundary line.

FIG. 16 illustrates an example case where an image is divided into two regions in the lateral direction and combined. In this case, the boundary line BL is set so as to be vertical.

In this case, a determination as to whether to allow combination is made on the basis of the distance between the lesion parts in the lateral direction of the image. That is, the determination is made on the basis of the distance H, in the lateral direction, between the lesion part (first lesion part) X1 in first image data and the lesion part (second lesion part) X2 in second image data. When the distance H is greater than or equal to a threshold value ThH, it is determined that combination of the two pieces of learning data is allowed. On the other hand, when the distance H is less than the threshold value ThH, it is determined that combination is not allowed.

New learning data is generated by combining regions that include the respective lesion parts. For example, when the lesion part is located in the region of the first image data on the left side of the boundary line, the image of the region of the first image data on the left side of the boundary line and the image of the region of the second image data on the right side of the boundary line are combined to generate new image data. On the other hand, when the lesion part is located in the region of the first image data on the right side of the boundary line, the image of the region of the first image data on the right side of the boundary line and the image of the region of the second image data on the left side of the boundary line are combined to generate new image data. New ground truth data is generated as well with a similar technique.

Form in which Setting of Boundary Line is Dynamically Changed

Although a form of image division is fixed in the above-described embodiment, a configuration may be employed in which the form is changed in accordance with learning data to be combined. That is, a configuration may be employed in which setting of the boundary line is dynamically changed in accordance with learning data to be combined.

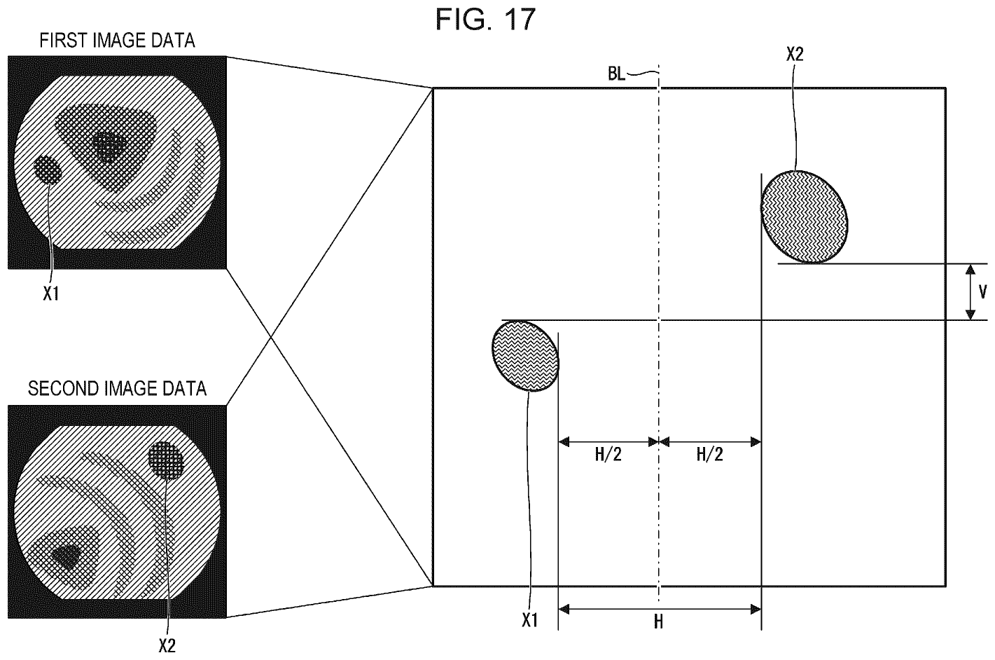

FIG. 17 is a diagram illustrating an example case of dynamically changing and setting a boundary line in accordance with learning data to be combined.

First, the distance V between the first lesion part X1 and the second lesion part X2 in the up-down direction of the image is calculated. It is determined whether the calculated distance V is greater than or equal to the threshold value ThV.

When the calculated distance V is greater than or equal to the threshold value ThV, the image is divided in the up-down direction to generate new learning data. In this case, a horizontal boundary line is set between the first lesion part X1 and the second lesion part X2. The image of the region on the upper side of the set boundary line and the image of the region on the lower side thereof are combined to generate new learning data.

On the other hand, when the calculated distance V is less than the threshold value ThV, the distance in the lateral direction is calculated. That is, the distance H between the first lesion part X1 and the second lesion part X2 in the lateral direction of the image is calculated. It is determined whether the calculated distance His greater than or equal to the threshold value ThH.

When the calculated distance H is greater than or equal to the threshold value ThH, the image is divided in the lateral direction to generate new learning data. In this case, a vertical boundary line (a boundary line that extends in the up-down direction of the image) is set between the first lesion part X1 and the second lesion part X2. The image of the region on the right side of the set boundary line and the image of the region on the left side thereof are combined to generate new learning data.

On the other hand, when the calculated distance His less than the threshold value ThH, it is determined that combination is not allowed.

As described above, when the boundary line is set in accordance with learning data to be combined, the number of combinations of pieces of learning data that are allowed to be combined can be increased.

Although a case where an image is divided along a horizontal or vertical boundary line has been described in the above-described example, a configuration can be employed in which the boundary line is obliquely set to divide the image. That is, as long as a configuration is employed in which the region of interest of one of the pieces of learning data is included in one of the regions separated by the boundary line and the region of interest of the other piece of learning data is included in the other region, the method for setting the boundary line is not specifically limited. Therefore, a broken line may be set as the boundary line or a curved line may be set as the boundary line.

A method for setting an optimum boundary line is not limited to the above-described example, and various methods can be employed. Therefore, a configuration can be employed in which an optimum boundary line is found directly from information about the position of the lesion part included in first learning data and information about the position of the lesion part included in second learning data.

### When Learning Data has Plurality of Regions of Interest

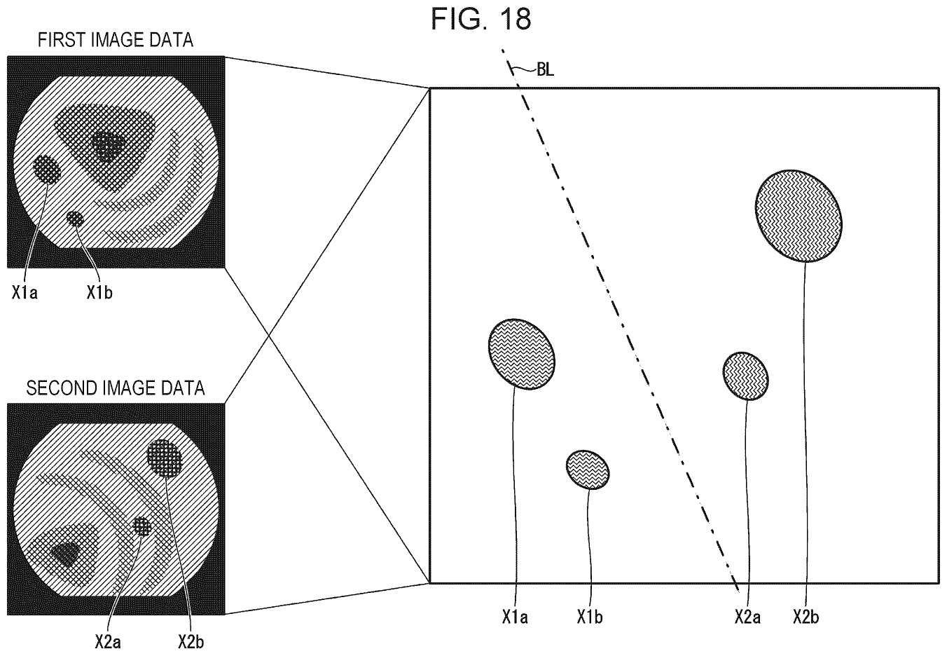

FIG. 18 is a diagram illustrating an example of setting a boundary line when learning data has a plurality of regions of interest.

As illustrated in FIG. 18, when pieces of learning data to be used in generation of new learning data (pieces of learning data to be used in combination) each have a plurality of regions of interest, it is preferable to set a boundary line such that all of the regions of interest of one of the pieces of learning data are included in one of the regions separated by the boundary line and all of the regions of interest of the other piece of learning data are included in the other region. Here, the state in which all of the regions of interest of one of the pieces of learning data are included in one of the regions separated by the boundary line means that all of the regions of interest of one of the pieces of learning data are included in one of the regions so as to be spaced apart from the boundary line by a predetermined threshold value or more. Similarly, the state in which all of the regions of interest of the other piece of learning data are included in the other of the regions separated by the boundary line means that all of the regions of interest of the other piece of learning data are included in the other region so as to be spaced apart from the boundary line by the predetermined threshold value or more.

In the example illustrated in FIG. 18, first learning data has two lesion parts (first lesion parts) X1a and X1b in its image data (first image data) and second learning data has two lesion parts (second lesion parts) X2a and X2b in its image data (second image data). In this case, the boundary line BL is set such that all of the lesion parts (first lesion parts X1a and X1b) in the first image data are located in one of the regions separated by the boundary line BL (the region on the left side of the boundary line BL in FIG. 18), and all of the lesion parts (second lesion parts X2a and X2b) in the second image data are located in the other region (the region on the right side of the boundary line BL in FIG. 18).

A prerequisite for combination is the condition that the distance between every lesion part in the first image data and every lesion part in the second image data is greater than or equal to a threshold value. When lesion parts closest to each other satisfy the condition, the other lesion parts satisfy the condition as a matter of course. Therefore, when lesion parts closest to each other is spaced apart from each other by the threshold value or more, it can be determined that combination is allowed.

### Learning Model Generation

A learning model generation method by using generated learning data will now be described. An example case of generating a learning model for recognizing a lesion part from an image captured with an endoscope, specifically, a learning model for recognizing a region occupied by a lesion part in an image (a learning model for performing image segmentation), will be described here.

### Learning Model Generation Apparatus (Learning Model Generation Method)

A learning model is generated by using a learning model generation apparatus. The learning model generation apparatus is formed of a computer. As this computer, the same computer used in generation of learning data can be used. Therefore, a description of the hardware configuration will be omitted.

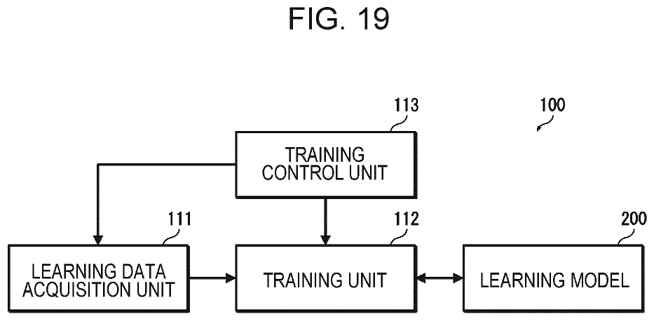

FIG. 19 is a block diagram of main functions of the learning model generation apparatus.

As illustrated in FIG. 19, a learning model generation apparatus 100 has functions of, for example, a learning data acquisition unit 111, which acquires learning data, a training unit 112, which trains a learning model 200 by using the acquired learning data, and a training control unit 113, which controls training. The function of each unit is implemented by a processor included in the computer executing a predetermined program (learning model generation program). The program to be executed by the processor, data necessary for, for example, processing, and so on are stored in an auxiliary storage device included in the computer.

The learning data acquisition unit 111 acquires learning data to be used in training. This learning data is new learning data (third learning data) generated by the learning data generation apparatus 1 described above. Pieces of learning data are stored in advance in the auxiliary storage device as a dataset. Therefore, the learning data acquisition unit 111 sequentially reads and acquires the pieces of learning data from the auxiliary storage device.

The training unit 112 trains the learning model 200 by using the pieces of learning data acquired by the learning data acquisition unit 111. As described above, as the learning model for performing image segmentation, for example, U-net, FCN, SegNet, PSPNet, or Deeplabv3+ can be used. Training of these learning models is a publicly known technique, and therefore, a detailed description thereof will be omitted.

The training control unit 113 controls, for example, acquisition of learning data by the learning data acquisition unit 111 and training by the training unit 112.

The learning model generation apparatus 100 thus configured trains the learning model 200 by using the learning data acquired by the learning data acquisition unit 111 to generate a learning model for performing desired image recognition. In this embodiment, the learning model generation apparatus 100 generates a learning model for recognizing the region of a lesion part from an endoscopic image. Here, the learning data acquired by the learning data acquisition unit 111 is learning data generated by combining a plurality of pieces of learning data. Therefore, an equivalent training effect is attained with a smaller number of pieces of data than in a case of training using the original pieces of learning data (pieces of learning data before combined). Furthermore, the training time can be shortened.

Generally, in deep learning, training using one dataset is repeatedly performed a plurality of times to generate a learning model having desired accuracy. Therefore, in this embodiment as well, the learning model is repeatedly trained a plurality of times by using a dataset formed of new learning data.

The generated learning model is applied to an apparatus or a system that performs image recognition. In this embodiment, the generated learning model is applied to an endoscope apparatus or an endoscope system. For example, the generated learning model is incorporated in an endoscopic image processing apparatus that processes an image (endoscopic image) captured with an endoscope, and is used in automatic recognition of a lesion part.

### Modifications

Training Using First Learning Data and/or Second Learning Data

At the time of training, not only new learning data but also learning data used in generation of the new learning data can be used.

For example, when two pieces of learning data (first learning data and second learning data) have been combined to generate new learning data, training using the first learning data and/or the second learning data can be performed in addition to training using the new learning data. In this case, the dataset may be formed of a combination of the first learning data and/or the second learning data, or when training is performed a plurality of times, training on some occasions may be replaced with training using the first learning data and/or the second learning data. As described above, in deep learning, training using one dataset is repeatedly performed a plurality of times to generate a learning model having desired accuracy. Therefore, a training configuration can be employed in which when training is repeatedly performed a plurality of times, training on at least one occasion is replaced with training using first learning data and/or second learning data. For example, a configuration can be employed in which a dataset formed of new learning data and a dataset formed of first learning data and/or second learning data are made ready, and training using each dataset is alternately performed. For example, training using each dataset is alternately performed such that first training is training using the dataset formed of first learning data and/or second learning data, second training is training using the dataset formed of new learning data, third training is training using the dataset formed of first learning data and/or second learning data, fourth training is training using the dataset formed of new learning data, and so on.

For example, a configuration can be employed in which a dataset formed of new learning data, a dataset formed of first learning data, and a dataset formed of second learning data are made ready, and training using each dataset is combined and performed. For example, training using each dataset is combined and performed such that first training is training using the dataset formed of first learning data, second training is training using the dataset formed of new learning data, third training is training using the dataset formed of second learning data, fourth training is training using the dataset formed of new learning data, and so on.

Note that in single training, all of the pieces of learning data that form the dataset need not be used, and only some of the pieces of learning data can be used to perform training.

As described above, when learning data used in generation of new learning data is used in training in addition to the new learning data, the influence of combination on training can be reduced. That is, the influence, on training, of a part in which the image changes can be reduced.

### Training Excluding Boundary Region

When a learning model is trained by using new learning data, a method for training while excluding a boundary region in image combination can be employed. In this case, for example, an excluded region that is within a certain range is set on both sides of the boundary line and is excluded from the learning target. For example, when new learning data has been generated on the basis of a fixed boundary line, the excluded region can be fixed to train the learning model. The size of the excluded region is set in consideration of an influence on training. Therefore, when this method is used in training of a neural network using a convolution process, it is preferable to set the size of the excluded region on the basis of the size of a receptive field. It is preferable to set at least one pixel on both sides of the boundary line as the excluded region.

### Other Embodiments

### Learning Model

Although an example case of generating a learning model for recognizing a lesion part from an endoscopic image has been described in the above-described embodiments, the generated learning model is not limited to this. The present invention is similarly applicable to generation of a learning model used for other purposes.

Although an example case of generating a learning model for performing image segmentation, specifically, semantic segmentation, has been described in the above-described embodiments, a learning model to which the present invention is applied is not limited to this. For example, the present invention is applicable to a case of generating, as the learning model for performing an image segmentation, a learning model for performing instance segmentation. As the learning model for performing instance segmentation, for example, Mask R-CNN or Masklab can be used. In addition, the present invention is applicable to a case of generating, for example, a learning model for performing image classification and a learning model for performing object detection.

### Ground Truth Data

Ground truth data is set in accordance with the model to be trained. Therefore, in a case of generating, for example, a learning model for performing object detection, ground truth data that indicates the position of a region of interest with, for example, a bounding box is generated. In this case, the ground truth data can be formed of, for example, coordinate information.

For a learning model for performing image classification, ground truth data that is image data is not necessary and ground truth data can be formed of only label information.

### Hardware Configuration

The functions of the learning data generation apparatus and the learning model generation apparatus can be implemented as various processors. The various processors include a CPU (central processing unit) and/or a GPU (graphic processing unit), which is a general-purpose processor executing a program to function as various processing units, a programmable logic device (PLD), such as an FPGA (field-programmable gate array), which is a processor for which the circuit configuration can be changed after manufacturing, and a dedicated electric circuit, such as an ASIC (application-specific integrated circuit), which is a processor having a circuit configuration that is designed only for performing a specific process. Note that “program” is synonymous with “software”.

One processing unit may be configured as one of the various processors or two or more processors of the same type or different types. For example, one processing unit may be configured as a plurality of FPGAs or a combination of a CPU and an FPGA. Furthermore, a plurality of processing units may be configured as one processor. As the first example of configuring a plurality of processing units as one processor, a form is possible in which one or more CPUs and software are combined to configure one processor, and the processor functions as the plurality of processing units, a typical example of which is a computer that is used in, for example, a client or a server. As the second example thereof, a form is possible in which a processor is used in which the functions of the entire system including the plurality of processing units are implemented as one IC (integrated circuit) chip, a representative example of which is a system on chip (SoC). As described above, regarding the hardware configuration, the various processing units are configured by using one or more of the various processors described above.

### REFERENCE SIGNS LIST

1 learning data generation apparatus
2 processor
4 auxiliary storage device
5 input device
6 output device
11 first learning data acquisition unit
12 position identification unit
13 second learning data acquisition unit
14 combination determination unit
15 new learning data generation unit
16 new learning data recording unit
21 first learning data acquisition unit
22 second learning data acquisition unit
23 distance calculation unit
24 combination determination unit
25 boundary line setting unit
26 new learning data generation unit
27 new learning data recording unit
100 learning model generation apparatus
111 learning data acquisition unit
112 training unit
113 training control unit
200 learning model
BL boundary line
UA upper-side region
LA lower-side region
RF receptive field
X lesion part
X1 lesion part (first lesion part)
X1a lesion part (first lesion part)
X2 lesion part (second lesion part)
X2a lesion part (second lesion part)
S1 to S9 procedure of new learning data generation process
S11 to S19 procedure of new learning data generation process

What is claimed is:

1. A learning data generation apparatus that generates learning data, comprising:
a processor,
the processor being configured to:
acquire first image data and second image data each having a region of interest; and
when a positional relationship between the region of interest of the first image data and the region of interest of the second image data satisfies a predetermined condition, combine an image of a region, of the first image data, that includes the region of interest and an image of a region, of the second image data, that includes the region of interest to generate third image data.

2. The learning data generation apparatus according to claim 1, wherein
the predetermined condition includes a condition that the region of interest of the first image data is located in a first region in an image and that the region of interest of the second image data is located in a second region different from the first region in the image.

3. The learning data generation apparatus according to claim 2, wherein
the predetermined condition includes a condition that the region of interest of the first image data is located in the first region so as to be spaced apart from a boundary line that separates the first region and the second region by a threshold value or more and that the region of interest of the second image data is located in the second region so as to be spaced apart from the boundary line by the threshold value or more.

4. The learning data generation apparatus according to claim 2, wherein
the predetermined condition includes a condition that a plurality of regions of interest of the first image data are located in the first region so as to be spaced apart from a boundary line that separates the first region and the second region by a threshold value or more and that a plurality of regions of interest of the second image data are located in the second region so as to be spaced apart from the boundary line by the threshold value or more.

5. The learning data generation apparatus according to claim 3, wherein
when the learning data is used in training of a neural network using a convolution process,
the threshold value is set on the basis of a size of a receptive field of a convolution layer in a first layer.

6. The learning data generation apparatus according to claim 2, wherein
the processor is configured to combine an image of the first region of the first image data and an image of a region, of the second image data, other than the first region to generate the third image data.

7. The learning data generation apparatus according to claim 6, wherein
the processor is configured to overwrite an image of a region, of the first image data, other than the first region with the image of the region, of the second image data, other than the first region to generate the third image data.

8. The learning data generation apparatus according to claim 1, wherein
the predetermined condition includes a condition that the region of interest of the first image data and the region of interest of the second image data are spaced apart from each other by a threshold value or more.

9. The learning data generation apparatus according to claim 8, wherein
the processor is configured to:
set a boundary line that separates a plurality of regions of an image, between the region of interest of the first image data and the region of interest of the second image data; and
combine an image of a region, of the first image data, that includes the region of interest among a plurality of regions, of the first image data, separated by the boundary line and an image of a region, of the second image data, that includes the region of interest among a plurality of regions, of the second image data, separated by the boundary line to generate the third image data.

10. The learning data generation apparatus according to claim 9, wherein
the processor is configured to overwrite an image of other than the region, of the first image data, that includes the region of interest with the image of the region, of the second image data, that includes the region of interest to generate the third image data.

11. The learning data generation apparatus according to claim 8, wherein
when the learning data is used in training of a neural network using a convolution process,
the threshold value is set on the basis of a size of a receptive field of a convolution layer in a first layer.

12. The learning data generation apparatus according to claim 1, wherein
the processor is configured to:
acquire first ground truth data that indicates a ground truth of the first image data and second ground truth data that indicates a ground truth of the second image data; and
generate third ground truth data that indicates a ground truth of the third image data from the first ground truth data and the second ground truth data.

13. The learning data generation apparatus according to claim 12, wherein
the processor is configured to generate third ground truth data that indicates a ground truth of the third image data from the first ground truth data and the second ground truth data in accordance with a condition for generating the third image data from the first image data and the second image data.

14. The learning data generation apparatus according to claim 12, wherein
each of the first ground truth data and the second ground truth data is mask data for the region of interest.

15. A learning model generation apparatus that generates a learning model, comprising:
a processor,
the processor being configured to:
acquire third image data generated by the learning data generation apparatus according to claim 1; and
train the learning model by using the third image data.

16. The learning model generation apparatus according to claim 15, wherein
the processor is configured to train the learning model by further using at least one image data among first image data and second image data used in generation of the third image data.

17. The learning model generation apparatus according to claim 16, wherein
the processor is configured to perform training using the third image data and training using at least one of the first image data or the second image data.

18. The learning model generation apparatus according to claim 15, wherein
the processor is configured to train the learning model while excluding a boundary region, of the third image data, in image combination.

19. A learning data generation method for generating learning data, comprising:
a step of acquiring first image data and second image data each having a region of interest;
a step of determining whether the region of interest of the first image data and the region of interest of the second image data have a specific positional relationship; and
a step of, when a positional relationship between the region of interest of the first image data and the region of interest of the second image data satisfies a predetermined condition, combining an image of a region, of the first image data, that includes the region of interest and an image of a region, of the second image data, that includes the region of interest to generate third image data.

20. A learning model generation method for generating a learning model, comprising:
a step of acquiring first image data and second image data each having a region of interest;
a step of, when a positional relationship between the region of interest of the first image data and the region of interest of the second image data satisfies a predetermined condition, combining an image of a region, of the first image data, that includes the region of interest and an image of a region, of the second image data, that includes the region of interest to generate third image data; and
a step of training the learning model by using the third image data.
